(19) United States
(12) Patent Application Publication
(10) Pub. No.: US 2012/0287237 A1
(43) Pub. Date: Nov. 15, 2012

(54) METHOD AND APPARATUS FOR PROCESSING VIDEO SIGNALS, RELATED COMPUTER PROGRAM PRODUCT, AND ENCODED SIGNAL

(75) Inventors: Emiliano Mario PICCINELLI, Cavenago Brianza (IT); Pasqualina FRAGNETO, Burago di Molgora (IT); Davide ALIPRANDI, Volongo (IT); Beatrice ROSSI, Milano (IT); Srijib Narayan MAITI, Noida (IN)

(73) Assignees: STMicroelectronics PVT LTD (INDIA), GREATER NOIDA (IN); STMicroelectronics S.r.l., Agrate Brianza (IT)

(21) Appl. No.: 13/469,873

(22) Filed: May 11, 2012

(30) Foreign Application Priority Data
May 11, 2011 (IT) TO2011A000414

(51) Int. Cl. H04N 13/00

(52) U.S. Cl. 348/43; 348/E13.062

(57) ABSTRACT

An embodiment of a method is disclosed for encoding a digital video signal including a first video sequence and a second video sequence jointly forming a stereo-view digital video signal. The method includes: subjecting the first video sequence to discrete cosine transform, quantization and run-length coding to produce a sequence of blocks of non-zero digital levels representative of the first video sequence, subjecting the second video sequence to discrete cosine transform, quantization, run-length coding and variable length coding to produce digital messages representative of the second video sequence, merging the bits of the digital messages into the sequence of blocks of digital levels by substituting the bits of the digital messages for respective Least Significant Bits of e.g. the last digital level in the blocks representative of the first video sequence to produce an encoded digital video signal representative of the first video sequence and the second video sequence.

### PRIORITY CLAIM

The instant application claims priority to Italian Patent Application No. TO2011A000414, filed May 11, 2011, which application is incorporated herein by reference in its entirety.

### TECHNICAL FIELD

An embodiment of the disclosure relates to processing of video signals. Certain embodiments may relate to techniques for merging a third dimension in 2D bi-dimensional or two-dimensional) video signals.

### SUMMARY

Multi Video Coding or MVC schemes may be further improved under at least two aspects:
reducing the overall amount of data transmitted to convey a stereo-view video signal; and
reducing the presence of unduly redundant processing modules/steps blocks provided in both processing (encoding and decoding) chains for the left and right sequences.

An embodiment provides such an improvement.

An embodiment refers to a method and corresponding apparatus (encoder and decoder) and to a computer program product, loadable in the memory of at least one computer and including software code portions capable of implementing the steps of the method when the product is run on at least one computer, as well as to a video signal encoded according to an embodiment.

An embodiment completely merges the bitstream generated by encoding the second view (e.g., the right view) into the bistream generated by encoding the first view (e.g., the left view), without adding any supplementary bit to the bitstream of the first view. This implies producing as a result what essentially looks like a “mono-view” video coded bitstream, even if it actually embeds a second view into it.

In an embodiment, the bitstream related to the second view may be generated either from the second stereoscopic view as such, or from said view presented in the form of a “depth map sequence”, namely a sequence of gray scale images, with values between black and white, which represent the distance between the objects shown within the frames and the camera that acquired the scene. In an embodiment, the second view can be either encoded by prediction from the first one (inter-view prediction MVC-like) or encoded independently (simulcast).

### BRIEF DESCRIPTION OF THE DRAWINGS

One or more embodiments will now be described, by way of example only, with reference to the annexed figures, wherein which:

FIGS. 1 to 7 are described below;

FIGS. 8 to 11 are representative of various steps in an embodiment;

FIGS. 12 and 13 are representative of an embodiment of an encoder; and

FIGS. 14 and 15 are representative of an embodiment of a decoder.

### DETAILED DESCRIPTION

Illustrated in the following description are various specific details aimed at an in-depth understanding of one or more embodiments. The one or more embodiments may be obtained without one or more specific details, or through other methods, components, materials, etc. In other cases, known structures, materials or operations are not shown or described in detail to avoid obscuring the various aspects of the embodiments. Reference to “an embodiment” in this description indicates that a particular configuration, structure or characteristic described regarding the embodiment is included in at least one embodiment. Hence, expressions such as “in an embodiment”, possibly present in various parts of this description do not necessarily refer to the same embodiment. Furthermore, particular configurations, structures or characteristics may be combined in any suitable manner in one or more embodiments. References herein are used for facilitating the reader and thus they do not necessarily define the scope of protection or the range of the embodiments.

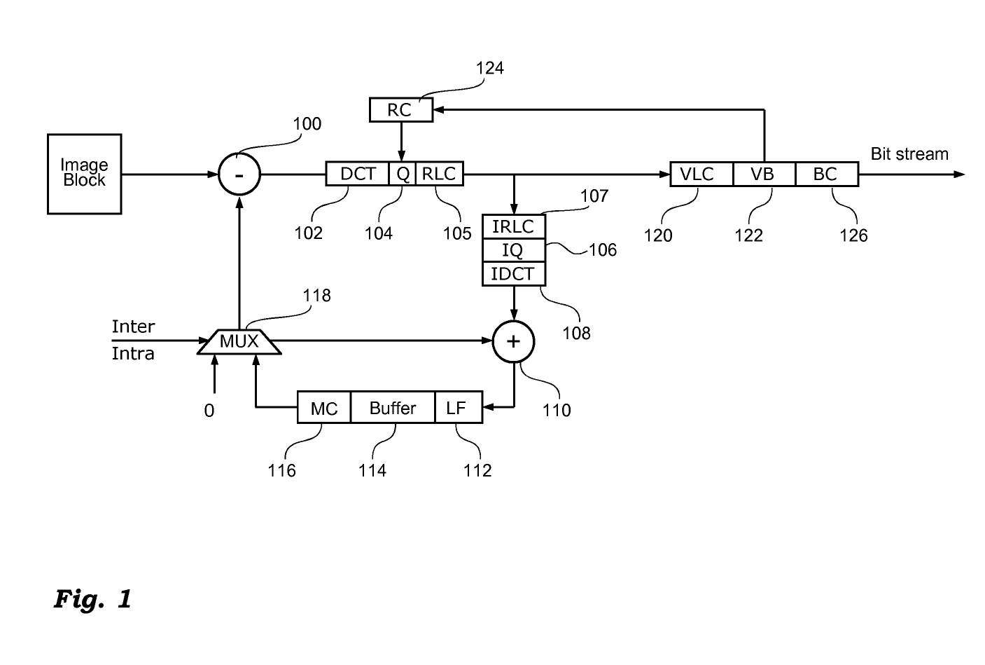

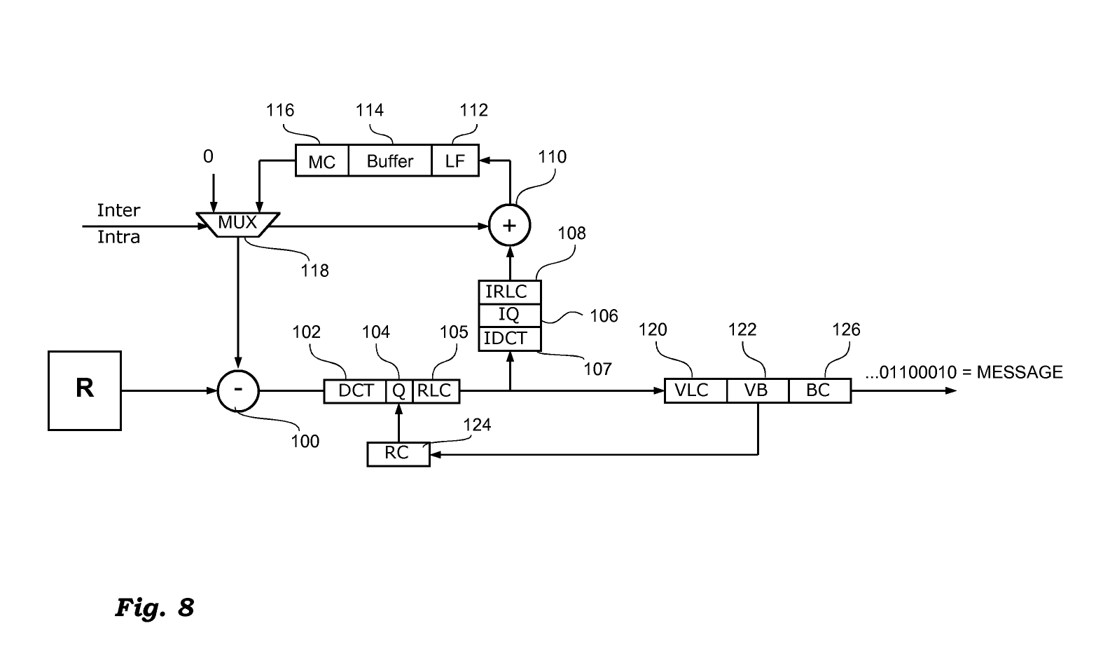

Parts, elements or functions identical or equivalent to parts, elements or functions described in connection with any of FIGS. 1 to 7 will be indicated in FIGS. 8 to 15 with the same references already used in FIGS. 1 to 7; the corresponding description will not be repeated in order to avoid making this description unduly lengthy.

Also, it will be appreciated that throughout this disclosure the roles played by the two sequences in a stereo video signal (i.e., right and left) can be exchanged: for instance, while the exemplary one or more embodiments described in the following refer to the “right” sequence being merged into the “left” sequence, various embodiments may provide for the “left” sequence being merged into the “right” sequence.

A simple way of representing three dimensions with a bi-dimensional image is a stereo method. A stereo image is configured with a right and left images, which may be inherently disadvantageous in view of the massive volume of data involved. In simple words, the amount of data that has to be stored and transmitted for stereo-view video applications may be twice as much if compared to conventional “mono” view video applications if a mono-view video coding method is applied directly.

It has been noted that, although not designed for stereo-view video coding, video coding tools such as, e.g., H.264 coding tools can be configured to take advantage of the correlations between the pair of views of a stereo-view video, and provide reliable and efficient compression performance as well as stereo/mono-view scalability.

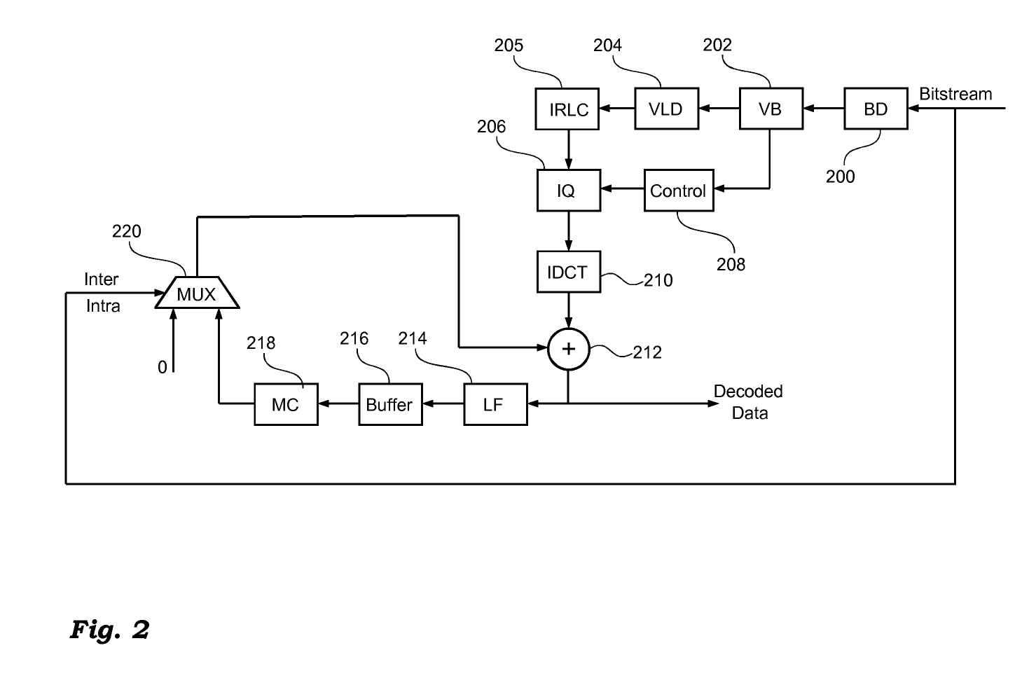

The block diagrams of FIGS. 1 and 2 are schematically representative of the structure and operation of an encoder (FIG. 1) and decoder (FIG. 2) operating on (mono) video images, e.g., in compliance with the H.264 standard.

In an embodiment, the encoder of FIG. 1 may include the following processing modules/steps:
100: Subtraction node (generates difference signal between input image block and output from Mux 118)
102: Discrete Cosine Transform (DCT)
104: Quantization with step Q
105: Run Length Coding (RLC)
106: Inverse Quantization, preceded by Inverse RLC (IRLC) 107
108: Inverse Discrete Cosine Transform (IDCT)
110: Summation Node (generates sum of signals output from IDCT 108 and Mux 118)
112: Loop Filter
114: Buffer (Frame memory)
116: Motion Compensation
118: Mux (to select between intra and inter prediction)
120: Variable Length Coding (VLC)—Entropy Coding
122: Variable Bitrate (VB)
124: Control of quantization step as a function of Variable Bitrate
126: Block Coding to produce encoded (e.g., H.264 encoded) output bitstream (Bitstream Coding)

In an embodiment, the decoder of FIG. 2 may include the following processing modules/steps:
200: Block Decoding of the encoded (e.g., H.264 encoded) bitstream
202: Variable Bitrate (VB)
204: Variable Length Decoding (VLD)
205: Inverse Run Length Coding (IRLC)
206: Inverse Quantization
208: Control of step for Inverse Quantization as a function of Variable Bitrate
210: Inverse Discrete Cosine Transform (IDCT)
212: Summation Node (generates sum of signal output from IDCT 210 and output from Mux 220 to produce Decoded Data)
214: Loop Filter
216: Buffer (Frame memory)
218: Motion Compensation
220: Mux (to select between intra and inter prediction bases on information derived from of the encoded bitstream).

The arrangements exemplified in FIGS. 1 and 2 are otherwise conventional in the art, which makes it unnecessary to provide a more detailed description herein. These arrangements may be configured to operate on images organized in blocks such as blocks including, e.g., 4×4 or 16×16 pixels.

Compression for stereo images can be achieved by taking advantage of redundancies in the source data, e.g., spatial and temporal redundancies for monocular images and video. The simplest solution for compressing the two channels is by using independent coding for each image/video with existing compression standards (H.264 Multicast Coding).

A stereoscopic video sequence contains a large amount of inter-view statistical dependencies, since the two cameras capture the same scene from two different viewpoints. Therefore, combined temporal and inter-view prediction may be a key for efficient stereoscopic coding. A frame from a given camera can be predicted not only from temporally related frames from the same camera, but also from the frames of any neighboring cameras. These interdependencies can be used for efficient prediction (Multi Video Coding or MVC).

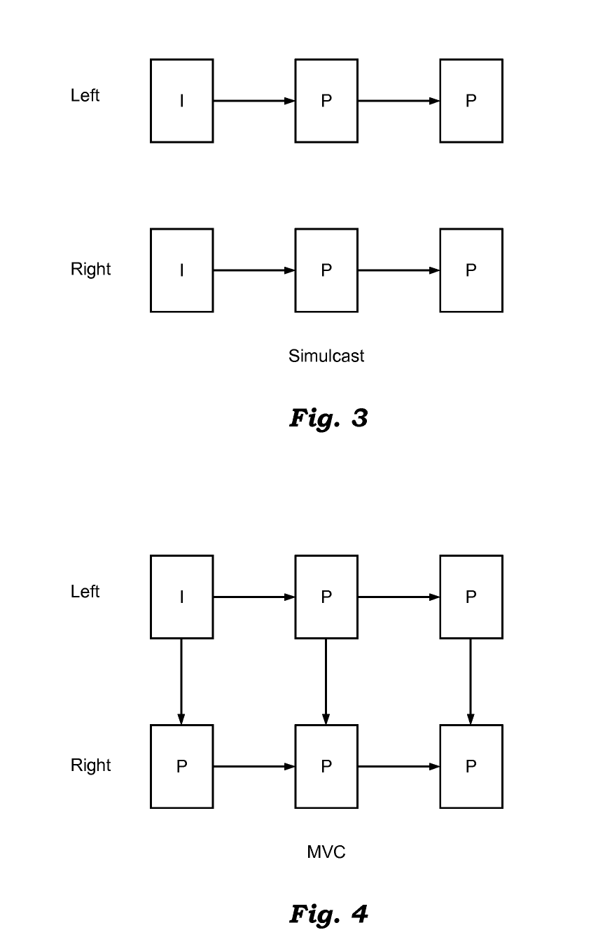

An exemplary coding architecture for stereoscopic video may be as represented in FIGS. 3 to 5.

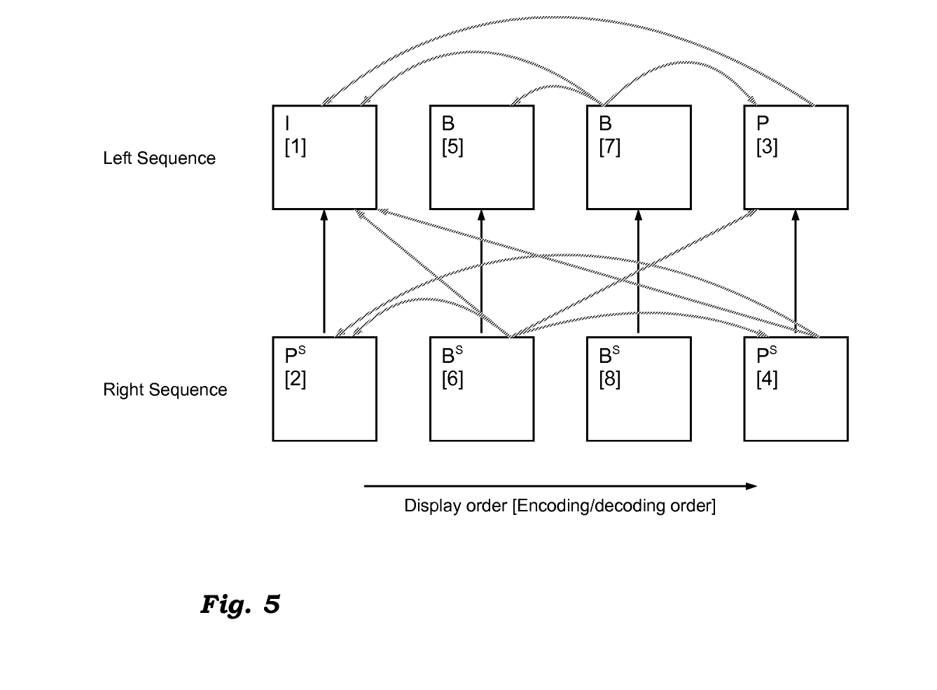

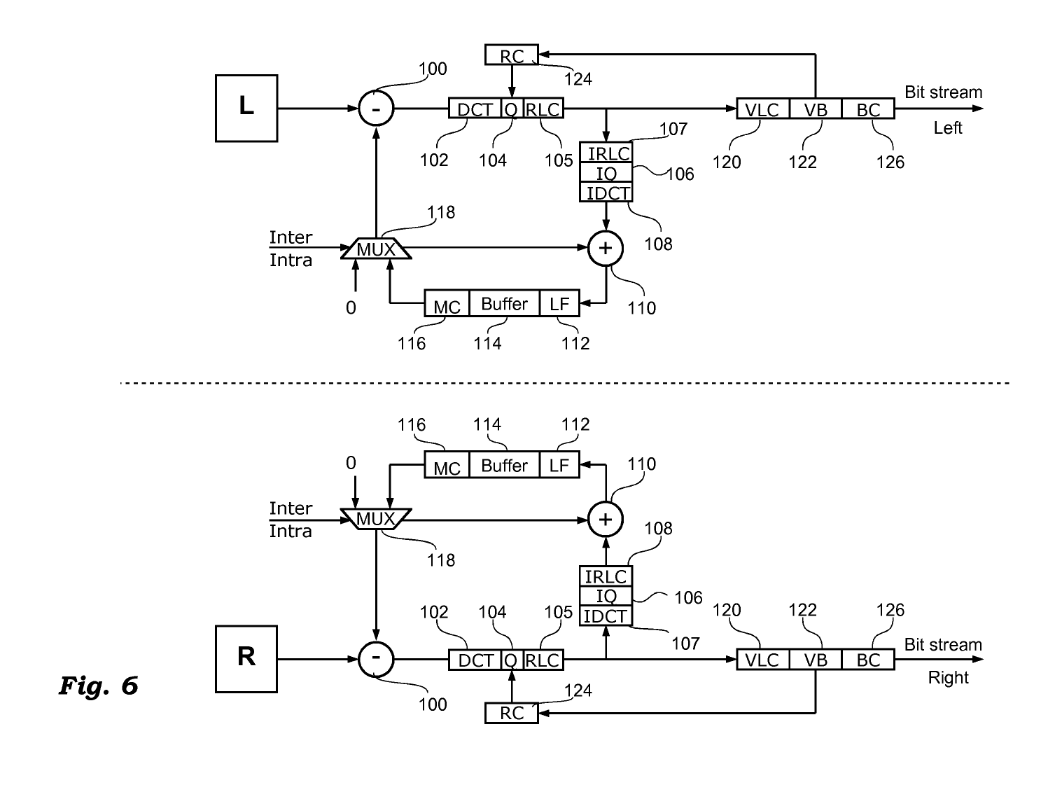

Specifically, FIGS. 3 and 4 show that, within the framework of a generic H.264 “simulcast” scheme as illustrated in FIG. 3, the possibility exists of using a same I-coded image from one of the two sequences—e.g., the left sequence for the purposes of prediction (P-coded images) also for the other sequence—e.g., the right sequence. FIG. 5 is exemplary of a way of displaying a stereo sequence which has been created according to FIGS. 3 and 4.

By way of further reference, FIG. 6 is representative of a “straightforward” stereo image encoding scheme based on the concept of duplicating the basic encoding scheme of FIG. 1—distinctly—for the left and right sequences, L and R, respectively, to produce corresponding “left” and “right” encoded (e.g., H.264) sequences.

The same reference numerals appearing in FIG. 1 have been reproduced in FIG. 6 to designate elements, parts or components which are identical or equivalent in the two figures: therefore, a detailed description of these elements, parts or components will not be repeated here.

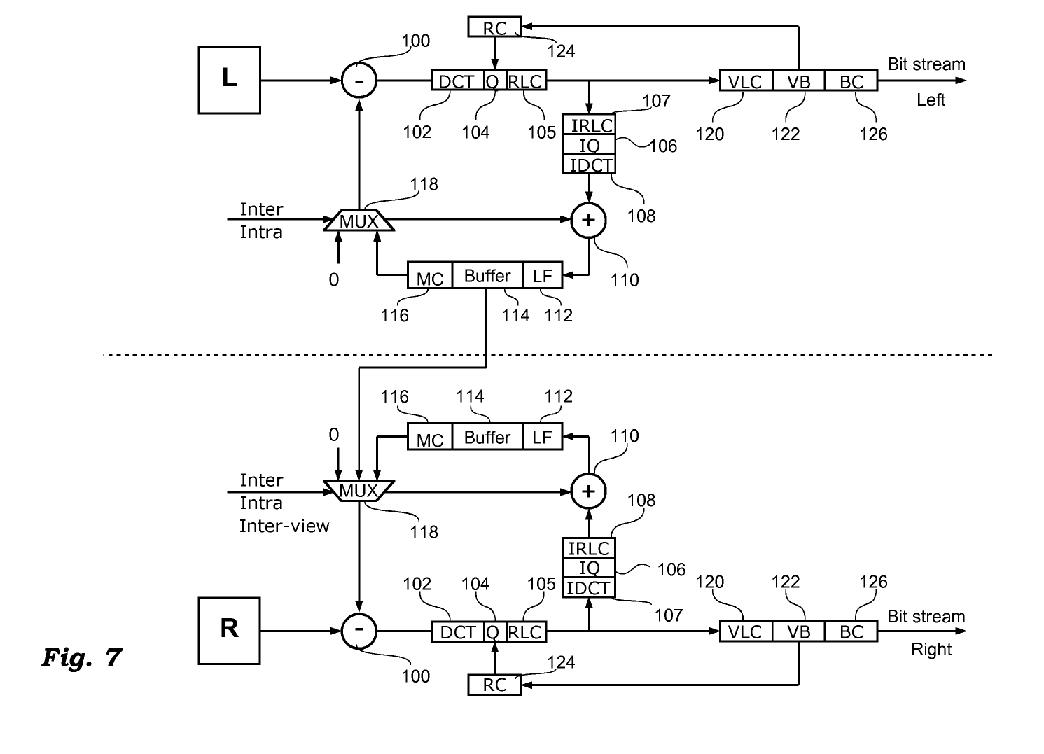

FIG. 7 is exemplary of the possibility of implementing a Multi Video Coding or MVC scheme by letting the two distinct encoders of FIG. 6 share some sort of prediction information, thus causing data coming from one of the sequences (e.g., the left sequence) being available to the node 118 of the encoder related to the second sequence (e.g., the right sequence). Specifically, the exemplary embodiment illustrated in FIG. 7 provides for data from the buffer 114 in the left sequence processing chain being made available at the mux node 118 in the right sequence processing chain, while a further possible “inter-view” value is contemplated for oration of the mux node 118.

It will be appreciated that processing arrangements dual to the encoding layouts of FIGS. 6 and 7 can be devised for complementary decoding layouts.

The diagram of FIG. 8 is representative of the possibility of subjecting one of the sequences in a stereo video signal (e.g., the right sequence) to a sequence of encoding modules/steps by means of which the sequence may be predicted (100, based on the signal produced in the modules/steps 106 to 118), transformed, quantized (modules/steps 102 to 105) and encoded (modules/steps 122 to 126) as usual, to obtain a sequence of bits jointly designated as MESSAGE, such as, e.g., an 8-bit bit string “01100010”.

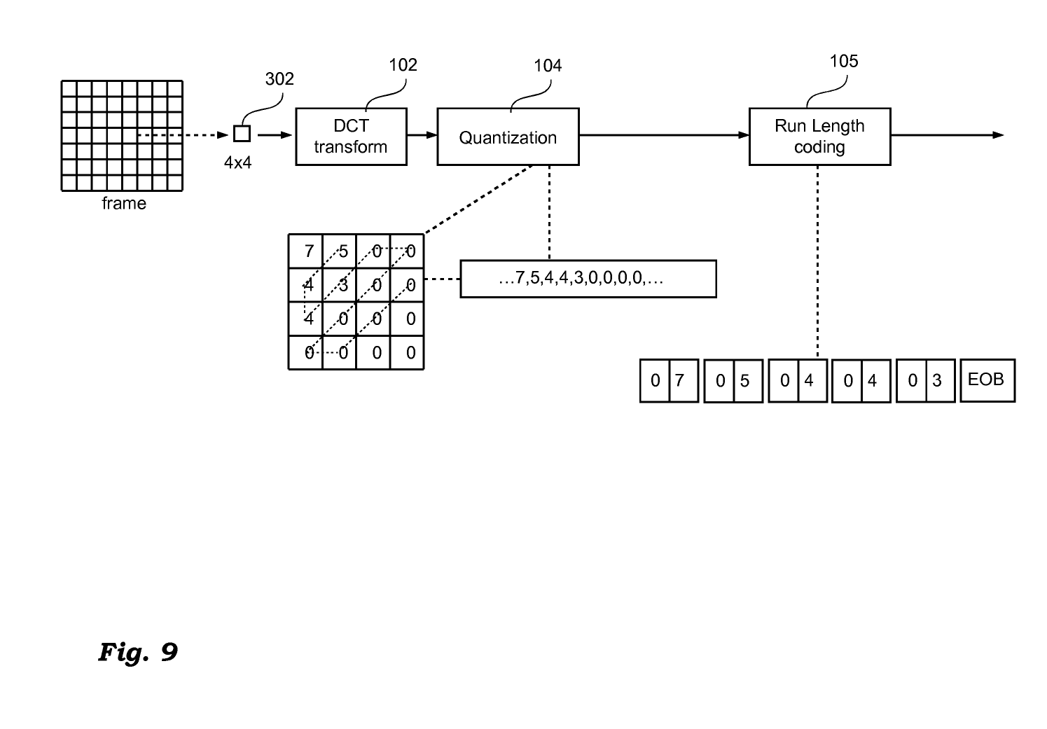

According to the variable block-size, it may be assumed that the message length is either less than 1/128 of the frame size if the block size in the encoder is set as small as 4×4, or less than 1/2048 if the block size is set as large as 16×16. As represented in FIG. 9, the other sequence in the stereo video signal (e.g., the left sequence, in the exemplary embodiment considered here) may be similarly subjected to a sequence of steps wherein, in each frame, blocks (e.g., 4×4) are extracted (step/module 302), transformed (step/module 102), quantized (step/module 104) and encoded using run-length coding (step/module 105) thus obtaining an encoded sequence wherein the levels resulting from quantization, e.g.,
. . . 7, 5, 4, 4, 3, 0, 0, 0, 0, . . .

are encoded as two-number entities wherein in each block the non-zero level is preceded by a “run” value, indicating the number of zeroes before level and terminated by an End Of Block (EOB) flag, namely:
[07] [05] [04] [03] [EOB]

wherein [03] is representative of the last (non-zero) level.

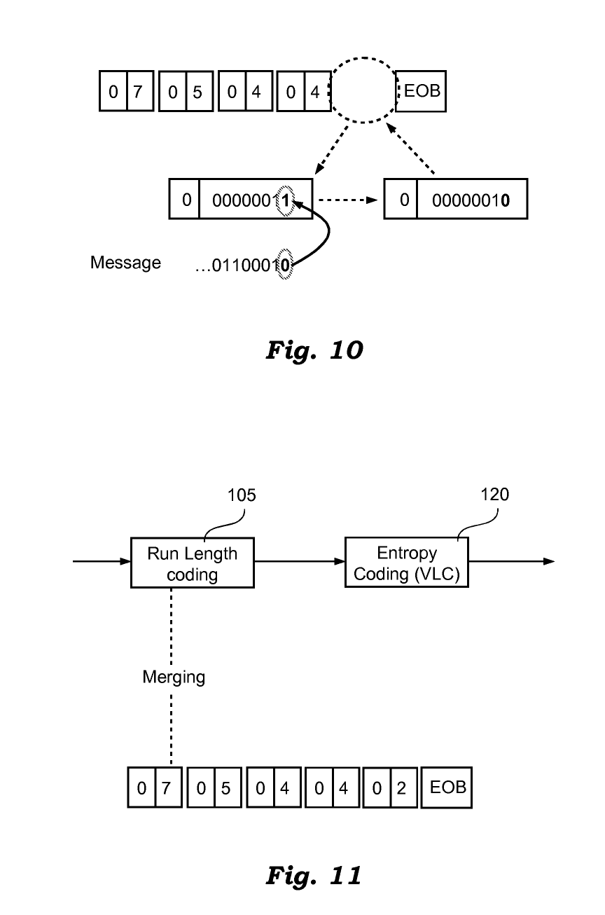

FIG. 10 is representative of an embodiment wherein the first sequence (here, the “right” sequence) is merged into the second sequence (here, the “left” sequence) by substituting each least significant bit (LSB) of one of the levels (e.g., the last level) of each block (e.g., 4×4) related to the sequence representative of the left video sequence with one bit of the “message” representative of the right video sequence.

In the exemplary case of FIGS. 9 and 10:
the “message” sequence obtained for the right video signal is “01100010”; and
the last level of the sequence representative of the left video sequence is “3”, that is “00000011” in 8-bit binary coding.

As schematically represented in FIGS. 10 and 11, each single bit (for instance the last bit in FIG. 10, i.e., “0”), of the “message” sequence obtained from the right video signal is substituted for the least significant bit (LSB) of the last level of the current block (e.g., 4×4) related to the sequence representative of the left video signal, thus yielding “00000010”, namely “2” in 8-bit binary form, instead of “00000011”, namely “3” as it was originally obtained from encoding of the left view only.

The thus modified sequence (i.e., with the last level modified from “3” to “2”, i.e., with [02] substituted for [03]) is encoded as usual using entropy encoding (VLC) in the module/step 120.

This procedure is repeated for each block until all the bits of the message are inserted into the left coding, so that the data for the right video signal is hidden in the “noise” of the image, producing an encoded signal, which may apparently look like a “mono-view” signal but in fact carries information of a “stereo-view” signal. In an embodiment, the bistream generated by encoding the right sequence can be considered as the message to be merged into the bitstream of the first view either in its entirety or only partly. In the latter case, the parts related to the information related to the structure of the bitstream itself (e.g., headers, sequence parameter set fields, picture parameter set fields, etc. . . . , i.e., those parts which do not contain data directly related to the images) are the same as those conveyed by the bitstream for the other (i.e., left) view; these parts can thus be derived from the left view bitstream when reconstructing the right view bitstream as described in the following.

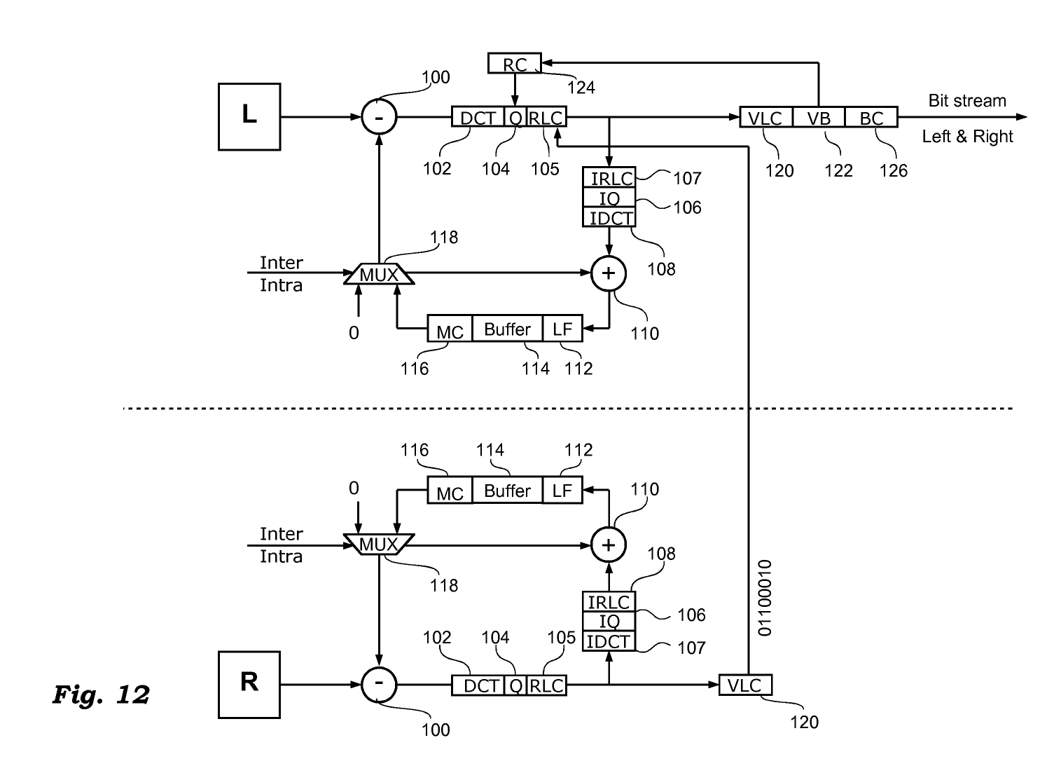

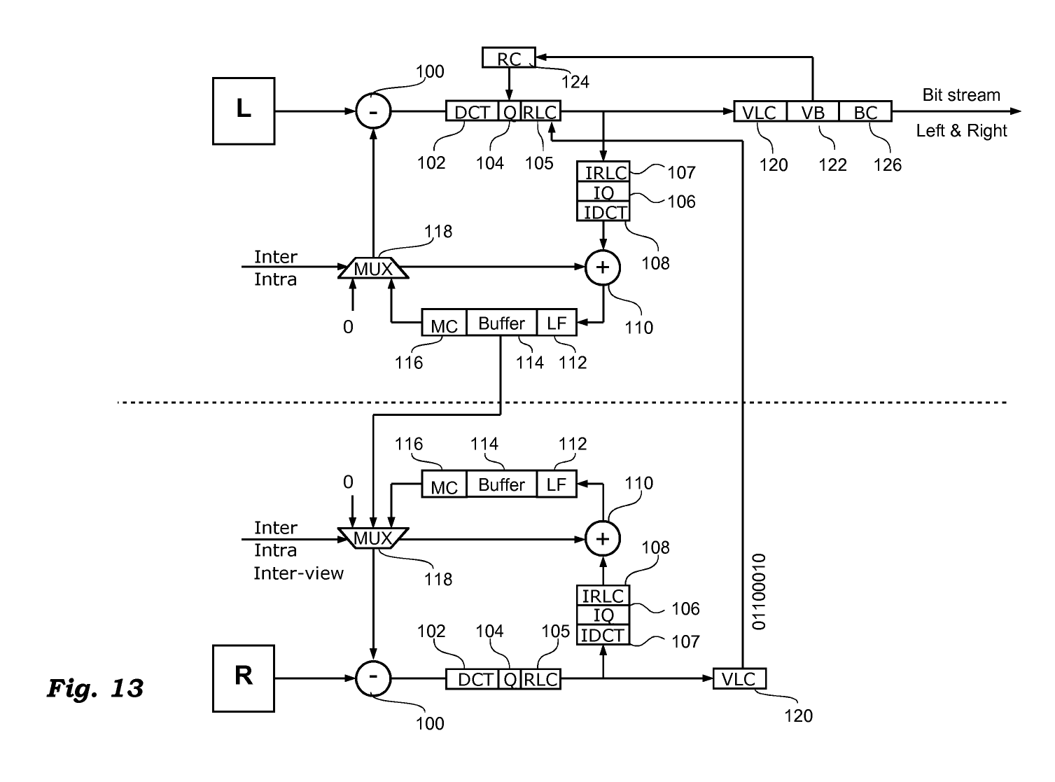

FIGS. 12 and 13 are schematic representation of encoders operating according to the exemplary “merging” criteria described in the foregoing (i.e., FIG. 12 represents a simulcast approach, whilst FIG. 13 shows an inter-view prediction (MVC-like) of the right view from the left one).

Again, parts, elements or functions identical or equivalent to parts, elements or functions already described in connection with any of the previous figures are indicated in FIGS. 12 and 13 with the same references already used in the previous figures; the corresponding description will not be repeated.

By direct comparison with FIG. 7, it will be further appreciated that in the diagrams of FIGS. 12 and 13, the processing arrangement for the left video sequence is approximately the same, while the processing arrangement for the right video sequence may be simplified.

In fact, generation of the message signal for the right video signal to be merged (e.g., at the level of the run-length coder 105 for the left sequence) into the left video sequence may dispense with separate processing modules/steps downstream of entropy (VLC) encoding 120 in the right-signal encoder, namely the modules/steps 122 and 126, and with the quantization step control module/step 124 as well.

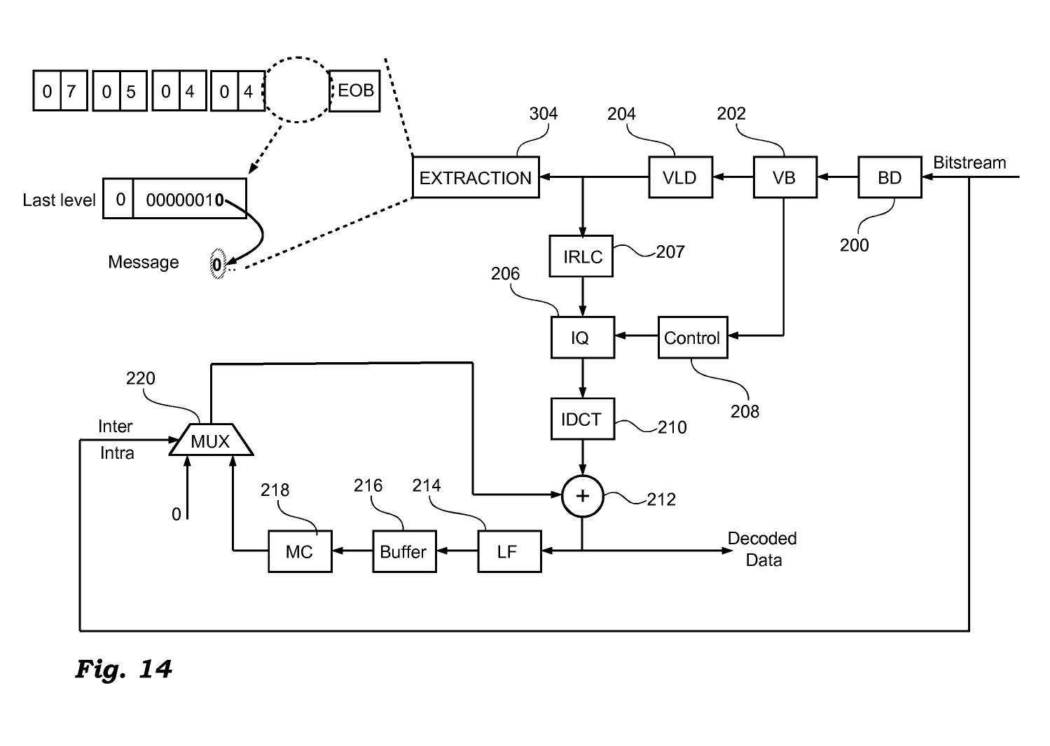

FIG. 14 is a schematic representation of a decoder adapted to decode the “merged” signal produced according to the exemplary “merging” criteria described in the foregoing in connection with FIGS. 8 to 13.

Once more, parts, elements or functions identical or equivalent to parts, elements or functions already described in connection with any of the previous Figures (e.g., FIG. 2) are indicated in FIG. 14 with the same references already used in the previous figures, and the corresponding description is not repeated.

In the exemplary decoder arrangement of FIG. 14, the left video signal is recovered (as is the case for the arrangement of FIG. 2) at the output of the adder 212.

In the exemplary decoder arrangement of FIG. 14, an extraction module/step 304 is provided located downstream of the module/step 204 where Variable Length Decoding (VLD) is performed to obtain the correspondent of the encoded sequence.

In the module/step 304, the least significant bit of each last level of the sequence is identified and collected to reconstruct the message representative of the right video signal as better detailed in the following.

Decoding of the left video signal proceeds otherwise as usual. The length of the message representative for the right video image will be expectedly lower than the number of transform blocks of the left (principal) view, otherwise at the decoder side an error while reconstructing the message might occur.

In that case, in certain embodiments, in order to preserve backward compatibility, the merging phase may operate at the frame level, that is by merging a right frame in the correspondent left one. Then, knowing the dimension of the image, the decoder may complete the extraction when the left frame is completely built.

The case that the length of the message representative for the right video image is higher than the number of transform blocks of the left (principal) view is highly unlikely.

In certain embodiments, one may set Constant Bit Rate (CBR) in the right view in order to be sure that the length is adequately small.

Extraction of the data for the right video signal merged into the left video signal takes place on the signal extracted at the module/step 304.

There, the least significant bit of each last level of the sequence is identified and collected to reconstruct the message.

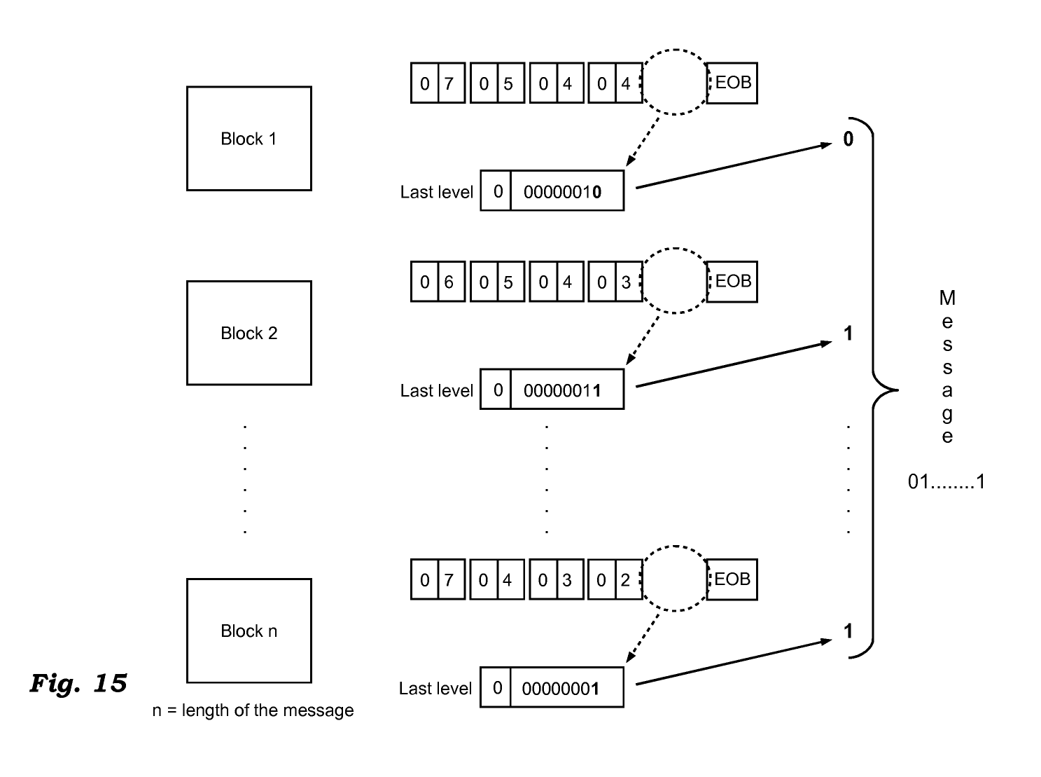

In certain embodiments, the whole bitstream corresponding to the right encoded view might be obtained either by just reconstructing the message from the bitstream for the left view as depicted in FIG. 15 (i.e., by extracting the LSB's from the last levels in each block before the EOB), or by properly merging the same extracted message with some information items common to the bitstream for the left view (e.g., header, sequence parameter set fields, picture parameters set fields, etc. . . . ) which are taken and copied from the bitstream related to the left view.

Variable Length Decoding (VLD) may be performed on the message reconstructed from the left view and decoding continues as usual.

It will be appreciated that certain embodiments may make it possible to achieve the following advantages:
the amount of encoded data transmitted for a stereo-view video signal is basically the same as for a mono-view video encoded signal, namely half of the correspondent transmitted data using e.g. H.264 multicast mode, and—in any case less than the corresponding data transmitted when using MVC;
an actual change in the resultant coding for the “principal” channel (in the examples considered herein, the left view into which the right view is merged) occurs statistically only in 50% of cases, and a change in the LSB of the last level of the sequence obtained after run-length coding introduces only a little amount of noise in the principal channel, which is not noticeable, or almost not noticeable, to the naked eye;
the encoded bitstream is consistent with a 2D decoder.

Without prejudice to the underlying principles of the disclosure, the details and embodiments may vary, even significantly, with respect to what has been described herein by way of non-limiting example only, without departing from the scope of the disclosure. Specifically, it will be appreciated that while provided in connection with the exemplary case of H.264 coding, the present disclosure is not limited to H.264 coding, but is generally applicable to any digital video signal including a first video sequence and a second video sequence jointly forming a stereo-view digital video signal, and wherein the first video sequence is subjected to discrete cosine transform, quantization and run-length coding to produce a sequence of blocks of non-zero digital levels representative of the first video sequence, while the second video sequence is subjected to discrete cosine transform, quantization, run-length coding and variable length coding to produce digital messages representative of the second video sequence.

Application of the disclosure can be detected also at the level of the resulting encoded digital video signal by comparing such a signal, which is representative of a first video sequence and a second video sequence jointly forming a stereo-view digital video signal, with a test signal produced based on the instant disclosure starting form the same video sequences. The encoded signal will include a sequence of blocks of non-zero digital levels representative of said first video sequence as subjected to discrete cosine transform, quantization and run-length coding, wherein the Least Significant Bits of one of the digital levels in the blocks representative of the first video sequence have substituted therefor the bits of digital messages representative of the second video sequence as subjected to discrete cosine transform, quantization, run-length coding and variable length coding, whereby the bits of the digital messages are merged into the sequence of blocks of digital levels.

An embodiment of the above-described encoders may be part of a system that includes an integrated circuit (e.g., a controller such as a microprocessor or microcontroller) coupled the encoder, where the encoder and integrated circuit may be disposed on a same or different dies.

Similarly, an embodiment of the above-described decoders may be part of a system that includes an integrated circuit (e.g., a controller such as a microprocessor or microcontroller) coupled the decoder, where the decoder and integrated circuit may be disposed on a same or different dies.

In closing, it is pointed out that an embodiment of a decoder such as described above needs only the information in a data stream encoded according to an embodiment such as described above to recover the first and second (e.g., left and right) image sequences. Although a conventional decoder may be able to recover the first image sequence from the data stream, the conventional decoder would be unable to recover the second image sequence from the data stream because it would not “know” what portion of the data stream represents the second image sequence; therefore, to a conventional decoder, the second image stream may appear as noise.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1.-11. (canceled)

12. An encoder, comprising:
a first encoder stage configured to encode first data; and
a second encoder state configured to encode second data in response to the encoded first data.

13. The encoder of claim 12 wherein:
the first data represents a first image; and
the second data represents a second image.

14. The encoder of claim 12 wherein:
the first data represents a first component of a stereoscopic image; and
the second data represents a second component of the stereoscopic image.

15. The encoder of claim 12 wherein:
the first data represents first video images; and
the second data represents second video images.

16. The encoder of claim 12 wherein:
the first data represents a first component of stereoscopic video images; and
the second data represents a second component of the stereoscopic video images.

17. The encoder of claim 12 wherein:
the first data represents a first component of three-dimensional video images; and
the second data represents a second component of the three-dimensional video images.

18. An encoder, comprising:
a first encoder stage configured to encode first data; and
a second encoder state configured to encode second data;
a combiner stage configured to combine the encoded first data and the encoded second data; and
a third encoder state configured to encode the combined encoded first data and encoded second data.

19. The encoder of claim 18 wherein:
the first data represents a first image; and
the second data represents a second image.

20. The encoder of claim 18 wherein:
the first data represents a first component of a stereoscopic image; and
the second data represents a second component of the stereoscopic image.

21. The encoder of claim 18 wherein:
the first data represents first video images; and
the second data represents second video images.

22. The encoder of claim 18 wherein:
the first data represents a first component of stereoscopic video images; and
the second data represents a second component of the stereoscopic video images.

23. The encoder of claim 18 wherein:
the first data represents a first component of three-dimensional video images; and
the second data represents a second component of the three-dimensional video images.

24. The encoder of claim 18 wherein:
the encoded first data includes blocks of encoded first data;
the encoded second data includes bits of encoded second data; and
the combiner is configured to combine a respective at least one bit of the encoded second data with a respective block of the encoded first data.

25. The encoder of claim 18 wherein:
the encoded first data includes a number of blocks of encoded first data;
the encoded second data includes a number of bits of encoded second data, the number of bits being less than or equal to the number of blocks; and
the combiner is configured to combine a respective at least one bit of the encoded second data with a respective block of the encoded first data.

26. A decoder, comprising:
a first decoder stage configured to decode first data; and
a second decoder state configured to decode second data in response to the decoded first data.

27. The decoder of claim 26 wherein:
the first data represents a first image; and
the second data represents a second image.

28. The decoder of claim 26 wherein:
the first data represents a first component of a stereoscopic image; and
the second data represents a second component of the stereoscopic image.

29. The decoder of claim 26 wherein:
the first data represents first video images; and
the second data represents second video images.

30. The decoder of claim 26 wherein:
the first data represents a first component of stereoscopic video images; and
the second data represents a second component of the stereoscopic video images.

31. The decoder of claim 12 wherein:
the first data represents a first component of three-dimensional video images; and
the second data represents a second component of the three-dimensional video images.

32. A decoder, comprising:
a first decoder stage configured to decode combined data;
an extractor configured to extract data from the decoded combined data;
a second decoder stage configured to decode the extracted data; and
a third encoder stage configured to decode further the decoded combined data.

33. The decoder of claim 32 wherein the combined data represents first and second images.

34. The decoder of claim 32 wherein the combined data represents first and second components of a stereoscopic image.

35. The decoder of claim 32 wherein the combined data represents first and second video images.

36. The decoder of claim 32 wherein the combined data represents first and second components of stereoscopic video images.

37. The decoder of claim 32 wherein the combined data represents first and second components of three-dimensional video images.

38. A system, comprising:
an encoder, including
a first encoder stage configured to encode first data; and
a second encoder state configured to encode second data in response to the encoded first data; and
an integrated circuit coupled to the encoder.

39. The system of claim 38 wherein the encoder and the integrated circuit are disposed on a same die.

40. The system of claim 38 wherein the encoder and the integrated circuits are disposed on respective dies.

41. The system of claim 38 wherein the integrated circuit includes a controller.

42. A system, comprising:
a decoder, including
a first decoder stage configured to decode first data; and
a second decoder state configured to decode second data in response to the decoded first data; and
an integrated circuit coupled to the decoder.

43. The system of claim 42 wherein the decoder and the integrated circuit are disposed on a same die.

44. The system of claim 42 wherein the encoder and the integrated circuit are disposed on respective dies.

45. The system of claim 42 wherein the integrated circuit includes a controller.

46. A method, comprising:
encoding first data; and
encoding second data in response to the encoded first data.

47. A method, comprising:
encoding first data;
encoding second data;
combining the encoded first data and the encoded second data; and
encoding the combined encoded first data and encoded second data.

48. A method, comprising:
decoding first data; and
decoding second data in response to the decoded first data.

49. A method, comprising:
decoding combined data;
extracting data from the decoded combined data;
decoding the extracted data; and
further decoding the decoded combined data.

50. A computer-readable medium storing instructions that when executed by an apparatus, cause the apparatus:
to encode first data; and
to encode second data in response to the encoded first data.

51. A computer-readable medium storing instructions that when executed by an apparatus, cause the apparatus:
to encode first data;
to encode second data;
to combine the encoded first data and the encoded second data; and
to encode the combined encoded first data and encoded second data.

52. A computer-readable medium storing instructions that when executed by an apparatus, cause the apparatus:
to decode first data; and
to decode second data in response to the decoded first data.

53. A computer-readable medium storing instructions that when executed by an apparatus, cause the apparatus:
to decode combined data;
to extract data from the decoded combined data;
to decode the extracted data; and
to decode further the decoded combined data.
